(19) United States
(12) Patent Application Publication
(10) Pub. No.: US 2019/0150426 A1
(43) Pub. Date: May 23, 2019

(54) WILD GAME TRAP AND ASSOCIATED SYSTEMS AND METHODS

(71) Applicant: Priefert Mfg. Co, Inc., Mt. Pleasant, TX (US)

(72) Inventor: Edward D. Priefert, Mt. Pleasant, TX (US)

(21) Appl. No.: 16/193,142

(22) Filed: Nov. 16, 2018

Related U.S. Application Data
(60) Provisional application No. 62/587,146, filed on Nov. 16, 2017.

(51) Int. Cl. A01M 23/38; A01M 23/08; A01M 23/18

(52) U.S. Cl. CPC A01M 23/38; A01M 23/18; A01M 23/08

(57) ABSTRACT

Certain disclosed embodiments include a self-baiting, self-catching, continuous wild game trap and its associated systems and methods. Such embodiments can include a catch trap, a corral, a plurality of cameras, a feeder, and various associated components. The single panel can be further used in isolation to encourage directional travel for use in parks and wildlife areas or in rotational grazing operations. Further implementations include systems having one or more single panels capable of providing directional movement of animals such that the systems can be used to encourage directional movement of animals in parks and wildlife areas or for rotational grazing of animals.

### CROSS-REFERENCE TO RELATED APPLICATION

This application claims the benefit under 35 U.S.C. § 119(e) to U.S. Provisional Application 62/587,146, filed Nov. 16, 2017 and entitled “Wild Game Trap and Associated Systems and Methods,” which is hereby incorporated herein by reference in its entirety.

### TECHNICAL FIELD

The embodiments disclosed relate to wild game traps that can be used to capture wild animals such as, for example, wild hogs, and more specifically to automated wild game traps.

### BACKGROUND

Wild or feral pigs are a tremendous liability to the U.S. agriculture industry. In addition to spreading diseases, feral hogs have reached populations of over five million and cause over a billion dollars in damages each year. In Texas, where the feral pig problem is particularly concerning, there are over 2 million feral pigs causing over $500 million in damages per year. Other wild animals also cause similar problems in the U.S. As such, there is a need in the art for an efficient, cost-effective method and system for trapping or otherwise containing certain wild animals, including wild pigs.

### BRIEF SUMMARY OF THE INVENTION

Discussed herein are various embodiments relating to a novel wild game trapping system. Certain implementations include a catch trap, corral, at least two cameras, a feeder, and various associated components, configured to allow for a relatively low-maintenance, continuous trapping system. Other embodiments relate to alternative trapping systems, one-way gating systems, and rotational grazing systems.

In Example 1, an automatic animal trap comprises an enclosure, a first one-way gate disposed in an outer barrier of the enclosure, and a first camera disposed to capture a first view of an interior of the enclosure, wherein the first camera is operably coupled to the first one-way gate.

Example 2 relates to the automatic animal trap according to Example 1, wherein the enclosure comprises a trap cage, and a corral adjacent to the trap cage.

Example 3 relates to the automatic animal trap according to Example 2, further comprising a second one way gate disposed between the trap cage and the corral, wherein the first one-way gate comprises an external gate of the trap cage.

Example 4 relates to the automatic animal trap according to Example 3, wherein the first view of the interior of the enclosure is a view of an interior of the trap cage.

Example 5 relates to the automatic animal trap according to Example 4, further comprising a second camera disposed to capture a second view of an interior of the corral, wherein the second camera is operably coupled to the second one-way gate.

Example 6 relates to the automatic animal trap according to Example 1, further comprising a game feeder disposed adjacent to and external to the enclosure.

Example 7 relates to the automatic animal trap according to Example 1, wherein the first one-way gate is configured to close when an animal is detected in the first view by the first camera.

In Example 8, an automatic animal trap comprises an enclosure comprising a trap cage, and a corral adjacent to the trap cage. Further, the trap also comprises a first one-way gate disposed between the trap cage and an external area outside of the enclosure, a second one-way gate disposed between the trap cage and the corral, a first camera disposed to capture a view of an interior of the trap cage, wherein the first camera is operably coupled to the first one-way gate, and a second camera disposed to capture a view of an interior of the corral, wherein the second camera is operably coupled to the second one-way gate. The first one-way gate is configured to close when an animal is detected by the first camera in the view of the interior of the trap cage, and the second one-way gate is configured to open when the first one-way gate is closed.

Example 9 relates to the automatic animal trap according to Example 8, further comprising a game feeder disposed adjacent to and external to the enclosure.

Example 10 relates to the automatic animal trap according to Example 8, further comprising a power source operably coupled to the first and second one-way gates and the first and second cameras.

Example 11 relates to the automatic animal trap according to Example 8, further comprising a solar panel operably coupled to the power source.

Example 12 relates to the automatic animal trap according to Example 8, wherein the second one-way gate is configured to close when an animal is detected by the second camera in the view of the interior of the corral.

In Example 13, a one-way gating system comprises a first barrier separating a first area from a second area, a first one-way gate disposed in the barrier, the first one-way gate comprising an open configuration and a closed configuration, wherein the open configuration is a default position, and a first camera disposed to capture a view of the second area adjacent to the first one-way gate, wherein the first camera is operably coupled to the first one-way gate. The first one-way gate moves into the closed configuration when the first camera detects an animal in the second area adjacent to the first one-way gate.

Example 14 relates to the one-way gating system according to Example 13, wherein the system is incorporated into a fence in a park or wildlife area.

Example 15 relates to the one-way gating system according to Example 13, wherein the system is incorporated into a set of fences in a pasture having a plurality of lots.

In Example 16, a rotational grazing system comprises an enclosure disposed around a pasture, at least first and second lots disposed within the enclosure, wherein the first area is the first lot and the second area is the second lot, and the first one-way gate of claim 13, wherein the barrier is a first barrier disposed between the first and second lots.

Example 17 relates to the rotational grazing system according to Example 16, the system comprising a third lot disposed adjacent to the second lot, a second barrier disposed between the second and third lots, a second one-way gate disposed in the second barrier, the second one-way gate comprising an open configuration and a closed configuration, wherein the open configuration is a default position, and a second camera disposed to capture a view of the third lot adjacent to the second one-way gate, wherein the second camera is operably coupled to the second one-way gate. The second one-way gate moves into the closed configuration when the second camera detects an animal in the third lot adjacent to the second one-way gate.

Example 18 includes an automatic trap, including a pen. The automatic trap also includes at least one gate. The automatic trap also includes a camera. The automatic trap also includes where the gate is in operational communication with the camera. Other embodiments of this Example 18 include corresponding computer systems, apparatus, and computer programs recorded on one or more computer storage devices, each configured to perform the actions of the methods. In various implementations, a system including one or more computers and/or cameras can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1A is a top view of a trapping system, according to one embodiment.

FIG. 1B is a perspective view of the trapping system of FIG. 1, according to one embodiment.

FIG. 2A is a perspective view of a trap cage, according to one embodiment.

FIG. 2B is another perspective view of the trap cage of FIG. 2A, according to one embodiment.

FIG. 2C is another perspective view of the trap cage of FIG. 2A, according to one embodiment.

FIG. 2D is another perspective view of the trap cage of FIG. 2A, according to one embodiment.

FIG. 3 is a top view of another trapping system, according to another embodiment.

FIG. 4A is a top view of a one-way gating system, according to one embodiment.

FIG. 4B is another top view of the one-way gating system of FIG. 4A, according to one embodiment.

FIG. 4C is another top view of the one-way gating system of FIG. 4A, according to one embodiment.

FIG. 5 is a top view of a rotational grazing system, according to another embodiment.

### DETAILED DESCRIPTION

The embodiments disclosed herein relate to devices, systems and methods for trapping of wild game, including, for example, wild hogs. More specifically, various embodiments relate to a trapping system that provides for automatic baiting and automatic catching of wild animals, such that constant presence of a human being is not required in order to effectively catch multiple animals.

Additionally, other implementations include systems having a single panel capable of providing directional movement of animals. Such single panel embodiments can be used in place of traditional one-way gates. As a result, the single panel systems can be used in parks and wildlife areas to encourage directional movement of an animal, and further can be incorporated into sections of fenced pasture for rotational grazing such that animals may pass directionally from one pasture area to another.

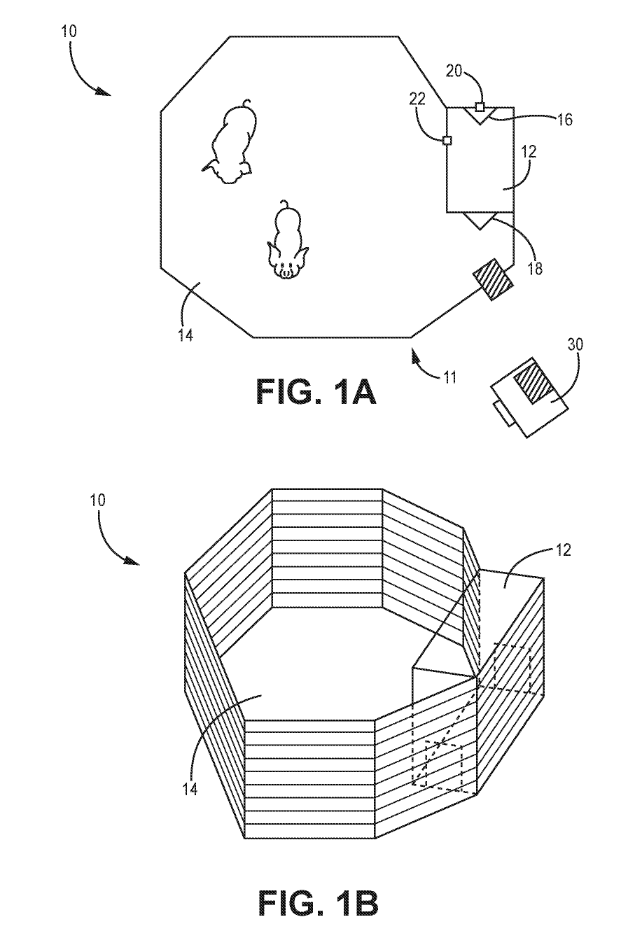

One example of a trapping system 10 according to one embodiment is shown in FIGS. 1A and 1B, in which the system 10 has a trapping pen 11 that includes a trap cage 12 and a corral 14. The trap cage 12 has two gates: a first or outer gate 16 and a second or inner gate 18. In one implementation, the system 10 also has a first or trap cage camera 20 and a second or corral camera 22. The first camera 20 is positioned on the trap cage 12 above the first gate 16 and is aimed into the trap cage 12 so that the first camera 20 captures images of the interior of the trap cage 12. The second camera 22 is positioned on one side of the trap cage 12 and is aimed into the corral 14 so that the second camera 22 captures images of the interior of the corral 14.

In certain embodiments, the system 10 also has a game feeder 30 that is positioned outside of the trapping pen 11 and is typically a slinging feeder 30 that spreads or otherwise distributes wild game food over an area surrounding the feeder 30, including into both the corral 14 and the trap cage 12. In one embodiment, the slinging feeder 30 is a corn-slinging feeder 30. Alternatively, the feeder 30 is any known feeder that can distribute food in a generally even distribution around the feeder 30.

The feeder 30, according to one embodiment, is positioned outside of and adjacent to the trapping pen 11 such that the feeder 30 is several feet from the pen 11. Alternatively, the feeder 30 can be positioned at a distance from the pen 11 ranging from about 0 to about 65 feet. In a further alternative, the feeder 30 can be positioned at any known distance from the pen 11 such that the feeder 30 can distribute food (such as, for example, corn) both into the corral 14 and the trap cage 12 from a position outside the pen 11.

In certain implementations, the system 10 also has a solar panel 32 positioned on or near the pen 11 that is connected to a rechargeable battery (not shown) such that the rechargeable battery (not shown) can be used as an energy source to power the actuators (not shown) that open and close the gates 16, 18. Alternatively, the power source can be a battery (not shown) that is recharged using some other method or apparatus. In a further alternative, the power source can be any known power source for powering known actuators such as those contemplated herein. It is understood that the actuators (not shown) can be any known motors or other types of actuators that can be used to open and close gates such as the gates 16, 18 disclosed or contemplated herein.

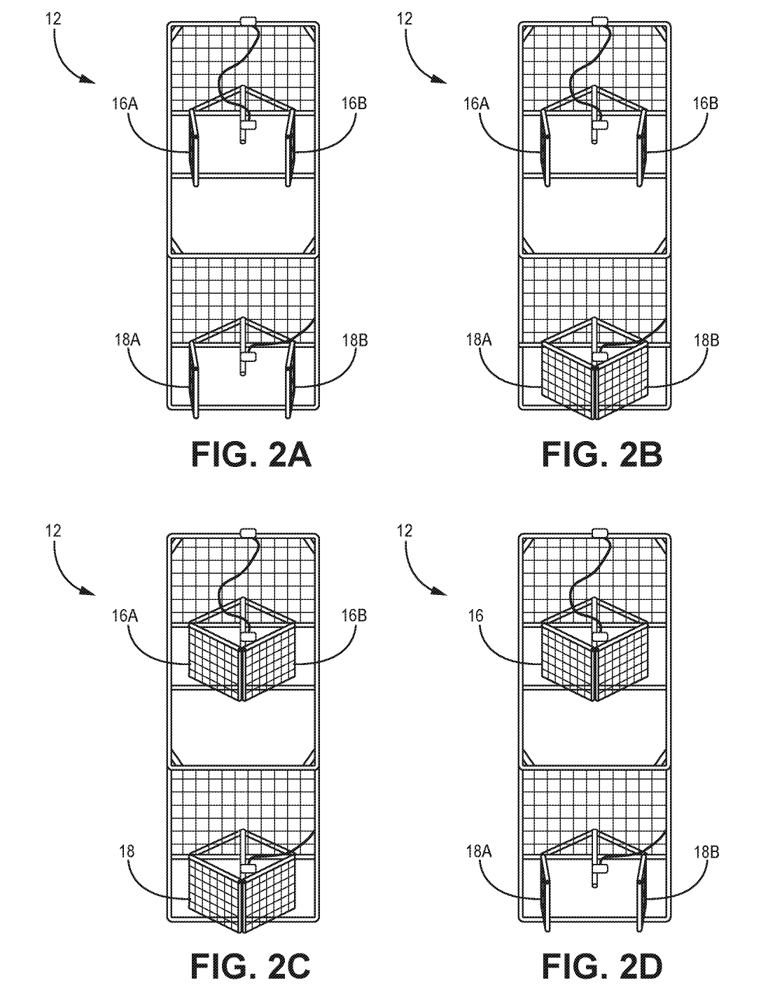

As best shown in FIGS. 2A-2D, the first and second gates 16, 18 are both two-paneled gates 16, 18 that can move between open and closed positions. More specifically, the first gate 16 has two gate panels 16A, 16B. The two gate panels 16A, 16B can move between a closed position as shown in FIGS. 2C and 2D to an open position as shown in FIGS. 2A and 2B. Similarly, the second gate 18 has two gate panels 18A, 18B that can move between a closed position as shown in FIGS. 2B and 2C to an open position as shown in FIGS. 2A and 2D. Alternatively, the gates 16, 18 can be any known gates for animal containment that can move between open and closed positions.

In accordance with one embodiment, the system 10 can be used to catch wild animals in a two-step process. First, the pen 11 is placed in “bait mode,” in which both the first and second gates 16, 18 are positioned in their open positions, as best shown in FIG. 2A, and the feeder 30 is actuated to distribute food into both the trap cage 12 and the corral 14. In this configuration, the gates 16, 18 are open such that animals can pass through the trap cage 12 and into the corral 14 to reach the food that has been distributed therein. In this “bait mode,” the system 10 actuates the corral camera 22 such that the camera 22 senses movement in the corral 14, thereby sensing the presence of wild animals. In one embodiment, the system 10 has been pre-programmed with a predetermined number of sensed movements such that when the threshold for sensed movements is exceeded, the system 10 is triggered to activate the “catch mode,” which is discussed in detail below. For example, the system 10 can be preprogrammed to trigger the catch mode when the corral camera 22 has sensed ten movements. Alternatively, the system 10 can be preprogrammed with any number of predetermined sensed movements.

One implementation of the camera 22 is configured to sense the size of the moving object. That is, the camera 22 is programmed or otherwise designed to distinguish between various sizes of the moving objects captured in its view. Further, this camera 22 can be pre-programmed to disregard any smaller moving objects, thereby only registering the movements of moving objects that are large enough to be the target wild animals, such as wild pigs.

In one embodiment, the camera 22 is preprogrammed to disregard any object that is smaller than desired targets. That is, various implementations of the system 10 comprise an image recognition system. In these implementations, the image recognition system evaluates captured images from the camera 22, such that candidate images from a motion detection algorithm can be classified for processing and execution of subsequent systems. For example, assuming that the trap has classified an image as a hog within a few minutes, the system is able to employ system logic to classify additional motion in the proximity of the identified hog as likely to be the same or another hog. Therefore, by using machine learning or other techniques, any new images passing the size threshold will be treated as hogs and the trap will respond accordingly.

Further, in certain of these implementations, the system 10 can be pre-programmed to execute one or more image classification filtering steps to prevent registering false positives and over-utilizing system resources. It is understood that an angled camera can distort the perceived size of objects and fast-moving animals or insects may register as a long, blurred object due to the long exposure time of each frame. Therefore, through the use of filtering implementations, the system 10 can implement image recognition processes via an algorithm prior to executing further image processing, such that the system 10 does not need to be very precise or robust to filter slow moving smaller moving objects—such as skunks, raccoons, birds and the like—and other noise. By filtering this “noise,” only sufficiently large and/or slow moving objects (target wild animals) can be sent to the image classifier part of the program which consumes more power and takes much more time to yield a classification. It is understood that these implementations ease system load and improve response times.

Alternatively, the camera 22 can be preprogrammed to disregard any desired size. While reference to programming the camera 22 is made here, it is understood that in certain implementations a supporting computer or other system in operational and electronic communication with the camera 22 may be programmed.

As mentioned above, when the corral camera 22 has sensed the predetermined number of movements of the predetermined size or other such predetermined parameters (such as speed, etc.) in the corral 14, the “catch mode” is triggered such that the system 10 actuates the second gate 18 to close, as shown in FIG. 2B. When the second gate 18 is closed, the animals in the corral 14 are captured therein. At this point, the system 10 also actuates the trap cage camera 20 such that the camera 20 detects any movement within the trap cage 12. The operation of the camera 20 can be identical to or substantially similar to the corral camera 22, such that the camera 20 senses movements within the trap cage 12. In this embodiment, the system 10 is preprogrammed such that when the camera 20 senses a single movement of a moving object of a predetermined size, the system 10 actuates the first gate 16 to close, as best shown in FIG. 2C, thereby capturing the sensed animal within the trap cage 12. Alternatively, the system 10 can be preprogrammed to actuate the first gate 16 to close upon sensing two movements, or any number of movements.

Continuing with the “catch mode,” once the first gate 16 is closed and the animal is thereby trapped in the trap cage 12, the system 10 actuates the second gate 18 to open as best shown in FIG. 2D, thereby allowing the animal to enter the corral 14. Once the animal exits the trap cage 12 and enters the corral 14 and the trap cage camera 20 senses no further movement in the trap cage 12 for a predetermined period of time, the system 10 actuates the second gate 18 to close and then actuates the first gate 16 to open, as best shown in FIG. 2B. At this point in the catch mode, the system 10 and/or pen 11 are configured to capture another animal in the trap cage 12 and repeat the catch mode process. In certain embodiments, this “resetting” of the system 10 to restart the catch mode also includes the system 10 actuating the feeder 30 to distribute food to at least the trap cage 12, thereby adding additional bait to draw additional animals.

It is understood that the system 10 described above and the various other embodiments discussed elsewhere herein can have any known hardware components as necessary to allow for operation of the camera(s) as described, operable coupling of the camera(s) and the gate(s), and transmission of electrical and/or electronic communications therebetween to operate the components as described herein. One of ordinary skill in the art would understand that various known components could be used with the systems herein.

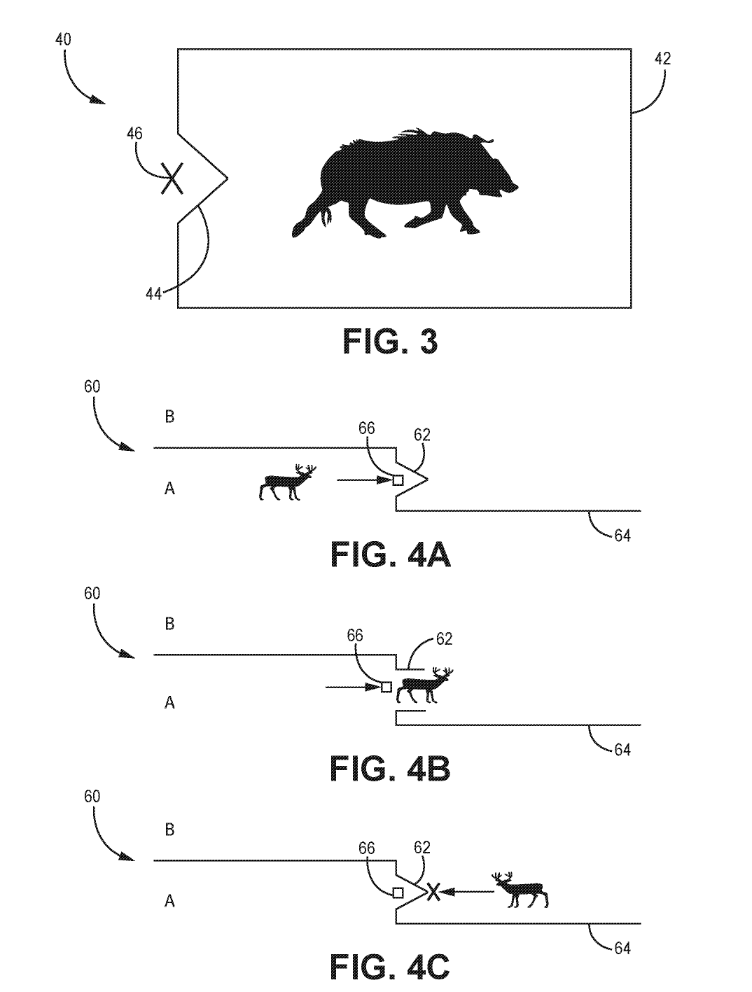

An alternative embodiment is shown in FIG. 3, which depicts a trap cage system 40 with a trap cage 42 having a single gate 44 and a single camera 46 that is positioned above the gate 44 to capture the interior of the cage 42. In this embodiment, the system 40 operates as follows. In use, the system 40 starts with the gate 44 in the open position, thereby allowing any wild animals access to the interior of the cage 42. The system 40 actuates the camera 46 to sense any movement within the cage 42. When the camera 46 senses movement of an object of a predetermined minimum size, the system 40 actuates the gate 44 to close, thereby trapping the animal in the cage 42.

According to a further alternative implementation in FIGS. 4A-4C, a variation of this type of system can be used for a one-way gating system 60 as shown. In this embodiment, the system 60 has a single gate 62 that is positioned along the length of a fence 64 to effect one-way movement of animals from one side of the fence 64 to the other. A camera 66 is disposed above the gate 62. In use, the default position of the gate 62 will be the open position such that animals can pass through the gate from side A of the fence 64 to the side B as shown in FIG. 4B. Further, the camera 66 will be positioned on the gate 62 such that it is aimed toward the area around the gate 62 on side B of the fence 64 such that the camera 66 will sense movement of any animals of any predetermined size on side B of the fence 64. If/when the camera 66 senses such movement on side B of the fence 64, the system 60 will actuate the gate 62 to close, thereby preventing any such animal from moving from side B to side A of the fence 64.

Alternatively, the gate 62 of system 60 can have two cameras disposed on the gate 62, with one aimed toward side A and one aimed toward side B. In this embodiment, the default position of the gate 62 is closed, and when the side A camera senses a qualifying movement, the system 60 triggers the gate 62 to open, and when the side B camera senses a qualifying movement, the system 60 triggers the gate 62 to close.

In both of the above embodiments, the system 60 allows for passage of the animal from side A to side B, but prevents passage from side B to side A.

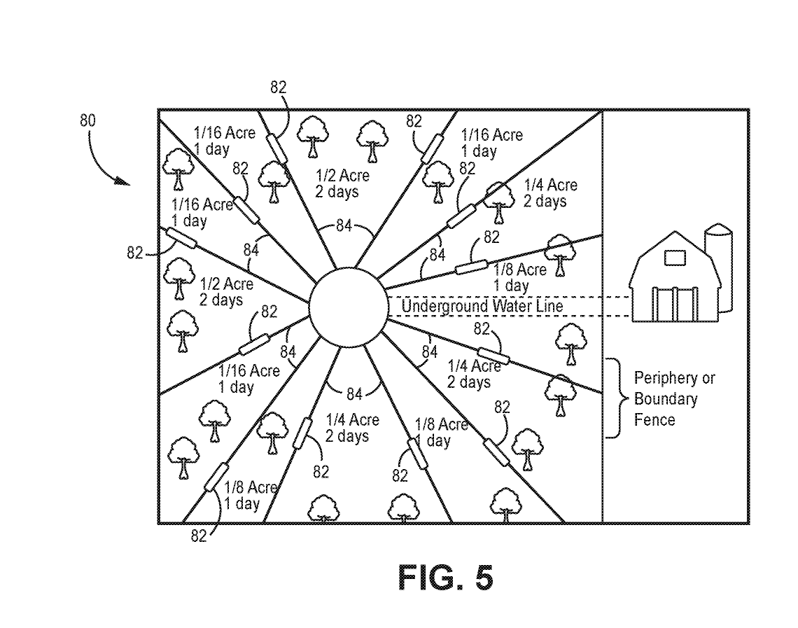

A further implementation is depicted in FIG. 5, which shows a rotational grazing system 80 having a pasture 86 with fences 84 that divide the pasture 86 up into multiple sections as shown. Each of the fences 84 has a gate 82 similar to the gates disclosed or contemplated herein. In one embodiment, the system 80 can operate based on predetermined times for a certain gate to open, thereby allowing animals to pass through to the desired section. In other words, the system 80 is preprogrammed to actuate a predetermined gate 82 to open such that the animals move from one section to another. In certain embodiments, each gate 82 can operate similarly to the one-way gating system embodiments discussed above, with each gate 82 having at least one camera (not shown) that can sense the movement of an animal and either open or close to ensure the desired one-way movement of the animals according to the various steps described above. For example, according to one specific embodiment, after a predetermined period of time in which all of the animals are in a first section of the pasture 86, the gate 82 between the first section and a second, adjacent section to which the animals are intended to be moved will be actuated to open. After a predetermined period, the gate 82 will be actuated to close. Alternatively, the system 80 can have at least one camera (not shown) positioned to capture images of the first section such that the gate 82 closes only after the camera detects no movement in the first section of the pasture 86 for some predetermined amount of time, thereby confirming that all of the animals have moved from the first section to the second section. Alternatively, the gate 82 can operate according to any of the various embodiments described elsewhere herein such that the animals can be rotated through the various sections of the pasture 86 in predetermined intervals to ensure that no overgrazing occurs in any given section.

Although the present invention has been described with reference to preferred embodiments, persons skilled in the art will recognize that changes may be made in form and detail without departing from the spirit and scope of the invention.

What is claimed is:

1. An automatic animal trap, comprising:
(a) an enclosure;
(b) a first one-way gate disposed in an outer barrier of the enclosure; and
(c) a first camera disposed to capture a first view of an interior of the enclosure,
wherein the first camera is operably coupled to the first one-way gate.

2. The automatic animal trap of claim 1, wherein the enclosure comprises:
(a) a trap cage, and
(b) a corral adjacent to the trap cage.

3. The automatic animal trap of claim 2, further comprising a second one way gate disposed between the trap cage and the corral, wherein the first one-way gate comprises an external gate of the trap cage.

4. The automatic animal trap of claim 3, wherein the first view of the interior of the enclosure is a view of an interior of the trap cage.

5. The automatic animal trap of claim 4, further comprising a second camera disposed to capture a second view of an interior of the corral, wherein the second camera is operably coupled to the second one-way gate.

6. The automatic animal trap of claim 1, further comprising a game feeder disposed adjacent to and external to the enclosure.

7. The automatic animal trap of claim 1, wherein the first one-way gate is configured to close when an animal is detected in the first view by the first camera.

8. An automatic animal trap, comprising:
(a) an enclosure comprising:
(i) a trap cage; and
(ii) a corral adjacent to the trap cage;
(b) a first one-way gate disposed between the trap cage and an external area outside of the enclosure;
(c) a second one-way gate disposed between the trap cage and the corral;
(d) a first camera disposed to capture a view of an interior of the trap cage, wherein the first camera is operably coupled to the first one-way gate; and
(e) a second camera disposed to capture a view of an interior of the corral, wherein the second camera is operably coupled to the second one-way gate,
wherein the first one-way gate is configured to close when an animal is detected by the first camera in the view of the interior of the trap cage,
wherein the second one-way gate is configured to open when the first one-way gate is closed.

9. The automatic animal trap of claim 8, further comprising a game feeder disposed adjacent to and external to the enclosure.

10. The automatic animal trap of claim 8, further comprising a power source operably coupled to the first and second one-way gates and the first and second cameras.

11. The automatic animal trap of claim 8, further comprising a solar panel operably coupled to the power source.

12. The automatic animal trap of claim 8, wherein the second one-way gate is configured to close when an animal is detected by the second camera in the view of the interior of the corral.

13. A one-way gating system, comprising:
(a) a first barrier separating a first area from a second area;
(b) a first one-way gate disposed in the barrier, the first one-way gate comprising an open configuration and a closed configuration, wherein the open configuration is a default position; and
(c) a first camera disposed to capture a view of the second area adjacent to the first one-way gate, wherein the first camera is operably coupled to the first one-way gate,
wherein the first one-way gate moves into the closed configuration when the first camera detects an animal in the second area adjacent to the first one-way gate.

14. The one-way gating system of claim 13, wherein the system is incorporated into a fence in a park or wildlife area.

15. The one-way gating system of claim 13, wherein the system is incorporated into a set of fences in a pasture having a plurality of lots.

16. A rotational grazing system comprising:
(a) an enclosure disposed around a pasture;
(b) at least first and second lots disposed within the enclosure, wherein the first area is the first lot and the second area is the second lot; and
(c) the first one-way gate of claim 13, wherein the barrier is a first barrier disposed between the first and second lots.

17. The rotational grazing system of claim 16, the system comprising:
(a) a third lot disposed adjacent to the second lot;
(b) a second barrier disposed between the second and third lots;
(c) a second one-way gate disposed in the second barrier, the second one-way gate comprising an open configuration and a closed configuration, wherein the open configuration is a default position; and
(d) a second camera disposed to capture a view of the third lot adjacent to the second one-way gate, wherein the second camera is operably coupled to the second one-way gate,
wherein the second one-way gate moves into the closed configuration when the second camera detects an animal in the third lot adjacent to the second one-way gate.
